(19) United States
(12) Patent Application Publication
(10) Pub. No.: US 2026/0017086 A1
(43) Pub. Date: Jan. 15, 2026

(54) User Interrupt Moderation for User Inter-Processor-Interrupts

(71) Applicant: Intel Corporation, Santa Clara, CA (US)

(72) Inventors: Zhan Xue, Shanghai (CN); Sohil Mehta, San Jose, CA (US); Bo Cui, Shanghai (CN)

(73) Assignee: Intel Corporation, Santa Clara, CA (US)

(21) Appl. No.: 18/994,383

(22) PCT Filed: Sep. 30, 2022
(86) PCT No.: PCT/CN2022/123618

§ 371 Date: Jan. 14, 2025

(51) Int. Cl. G06F 9/48

(52) U.S. Cl. CPC G06F 9/4837

(57) ABSTRACT

Methods and apparatus relating to techniques for user interrupt moderation of user Inter-Processor-Interrupts (IPIs) are described. In an embodiment, a processor executes a receiver process to process a user Inter-Processor Interrupt (IPI) from a sender process. A memory stores User Inter-Processor Interrupt Moderation Configuration (UIMC) data to be accessed by the receiver process. In response to a comparison of a number of invocations of the user IPI during a time interval and an interrupt throttle rate, it is determined whether to drop the user IPI. Other embodiments are also disclosed and claimed.

### FIELD

The present disclosure generally relates to the field of processors. More particularly, some embodiments relate to user interrupt moderation for user Inter-Processor-Interrupts (IPIs).

### BACKGROUND

Generally, a “user interrupt” refers to a kernel-bypass mechanism to deliver events to a user space with very low latency. One of the mechanisms allows one process to send a user IPI to another process directly via hardware by invoking a SENDUIPI instruction.

However, a user IPI may only support a posted interrupt delivery mechanism. As a result, the sender is expected to also confirm the user IPI delivery by another mechanism (such as shared memory or another user IPI from the receiver) and then retry the operation if needed. Different user IPIs may be distinguished by a 6-bit user-interrupt vector. For example, vector number 63 may have the highest priority while vector number 0 would have the lowest. Hence, each receiver can receive up to 64 unique IPI events.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates a system to support user IPI moderation according to an embodiment.

FIG. 2 illustrates a block diagram of an extended User Posted Interrupt Descriptor (UPID) with User IPI Moderation Configuration (UIMC), according to an embodiment.

FIG. 3 illustrates a sample pseudocode using an instruction for user IPI moderation, according to an embodiment.

FIG. 4 illustrates a flow diagram of a method for periodical clearance of an interrupt counter, according to an embodiment.

FIG. 5 illustrates an example computing system.

FIG. 6 illustrates a block diagram of an example processor and/or System on a Chip (SoC) that may have one or more cores and an integrated memory controller.

FIG. 7(A) is a block diagram illustrating both an example in-order pipeline and an example register renaming, out-of-order issue/execution pipeline according to examples.

FIG. 7(B) is a block diagram illustrating both an example in-order architecture core and an example register renaming, out-of-order issue/execution architecture core to be included in a processor according to examples.

FIG. 8 illustrates examples of execution unit(s) circuitry.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware (such as logic circuitry or more generally circuitry or circuit), software, firmware, or some combination thereof.

As mentioned above, a user IPI may be used to deliver events to a user space with very low latency. A user IPI is generally a faster and more efficient alternative to using Inter-Processor Communication (IPC). But, there is no mechanism to moderate a user IPI (using the SENDUIPI instruction) when it is initiated by an unprivileged user, so it cannot overutilize system resources. Currently, system software needs to restrict user IPI communications to only trusted and cooperative processes. For example, if a sender process maliciously (or unintentionally) generates a significant number of user IPIs in a short time, the interrupt load on the receiver will ramp up which could significantly impact the execution of the receiver's other activities. If the receiver process is busy performing high-priority work, it would need to temporarily inhibit lower-priority user IPIs. Hence, it is important to throttle the user interrupt storm to guarantee the receiver's normal execution and provide some sort of Quality of Service (QOS) to high priority requests. This would be different from disabling interrupt processing altogether.

To this end, some embodiments provide techniques for user interrupt moderation of user IPIs. In an embodiment, user IPI moderation (or throttling) of user IPIs (such as those initiated by a SENDUIPI instruction) is provided to address the above problems. One or more embodiments may allow communication between non-trusted and/or non-cooperative processes.

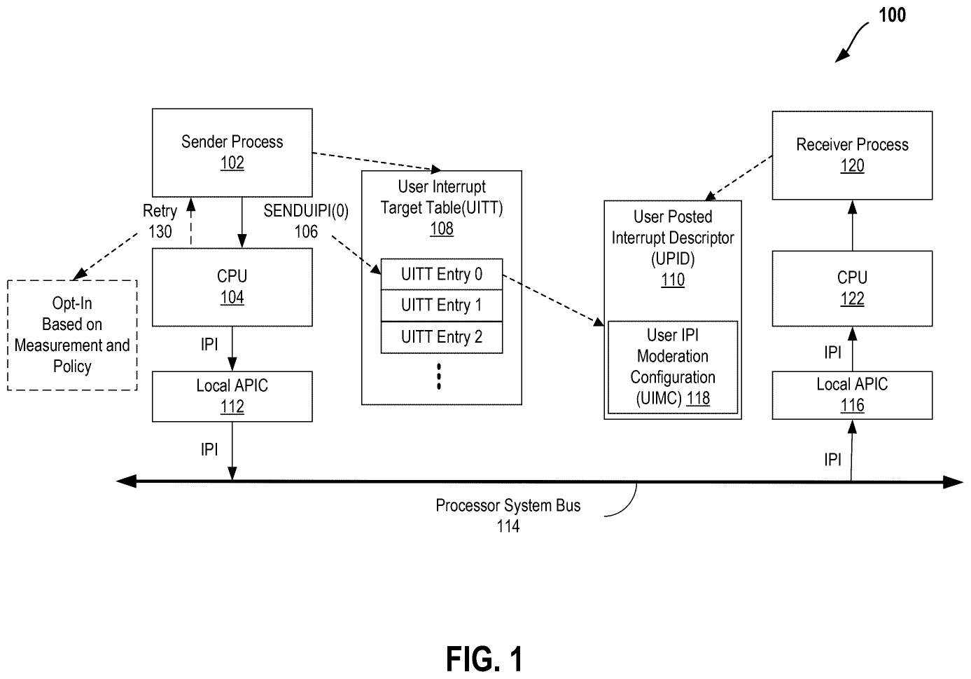

FIG. 1 illustrates a system 100 which supports user IPI moderation according to an embodiment. An embodiment provides a mechanism for user interrupt moderation to limit the amount of user IPIs per a specified time interval that a process may generate (e.g., using a SENDUIPI instruction). It starts/stops throttling user IPI generation based on a measurement and one or more configured policies.

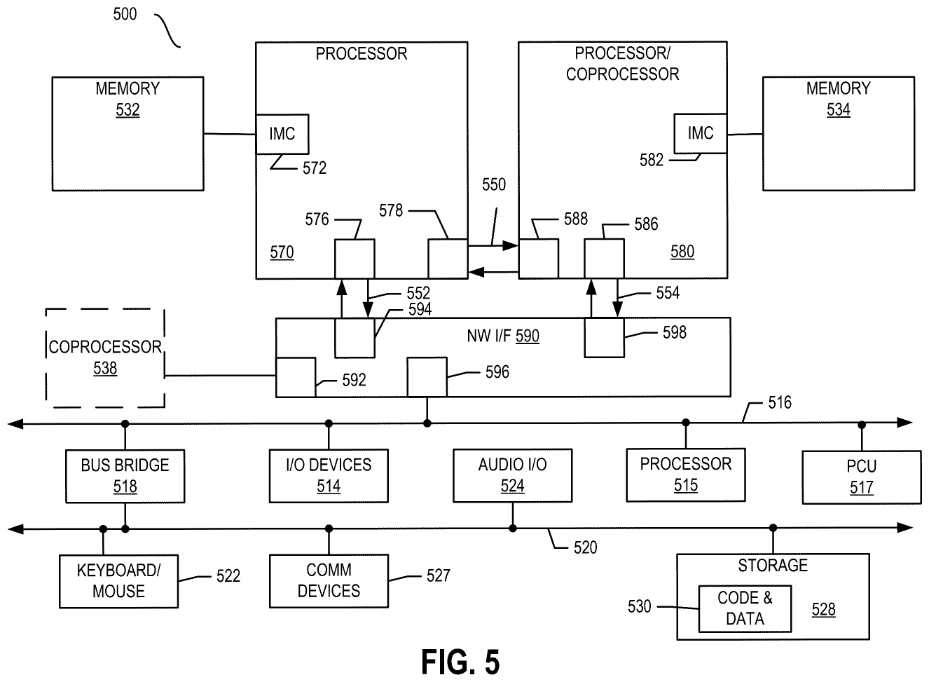

Referring to FIG. 1, a sender process 102 (e.g., executing on a Central Processing Unit (CPU) 104 or another processor such as those discussed with reference to FIG. 5 et seq.) may generate a user IPI (e.g., using a SENDUIPI instruction 106) based on a User Interrupt Target Table (UITT) 108 in kernel. Each UITT entry contains the linear address of a User Posted Interrupt Descriptor (UPID) 110. While FIG. 1 only shows three entries for illustrative simplicity, embodiments are not limited to a specific number of entries and more or less entries may be used depending on the implementation. The user IPI is then forwarded via a local Advanced Programmable Interrupt Controller (APIC) 112 to a processor system bus 114 and then to a local APIC 116 (associated with a receiver process 120).

As shown, the UPID 110 may include a User IPI Moderation Configuration (UIMC) storage 118, which may store values for an interrupt throttle rate, an interrupt counter, and a time interval for the receiver process 120 (executing on a CPU 122 or another processor such as those discussed with reference to FIG. 5 et seq.). When the amount (or the number) of a user IPI in a specific time interval is equal to or greater than (or exceeds) the configured interrupt throttle rate, that IPI is dropped without generating a user IPI to a local Advanced Programmable Interrupt Controller (APIC) 116. Throttling at the interrupt source may avoid the overhead of IPI on the processor system bus 114 and identification and processing at the receiver side for the whole system.

It may be useful to inform the sender process 102 that a user IPI execution was throttled and therefore an exception (e.g., a General Protection (#GP) fault) or an error status (e.g., an indication to retry) can be returned. The mechanism to return a retry status by setting the Zero Flag (ZF) flag is described below (e.g., using a retry status). It would then be up to the sender process 102 to determine an appropriate backoff and then retry 130 (e.g., based on a measurement and one or more configured policies). This enables the receiver process 120 to dynamically set the moderation parameters for different allowed IPI rates as its processing state and needs/implementation vary.

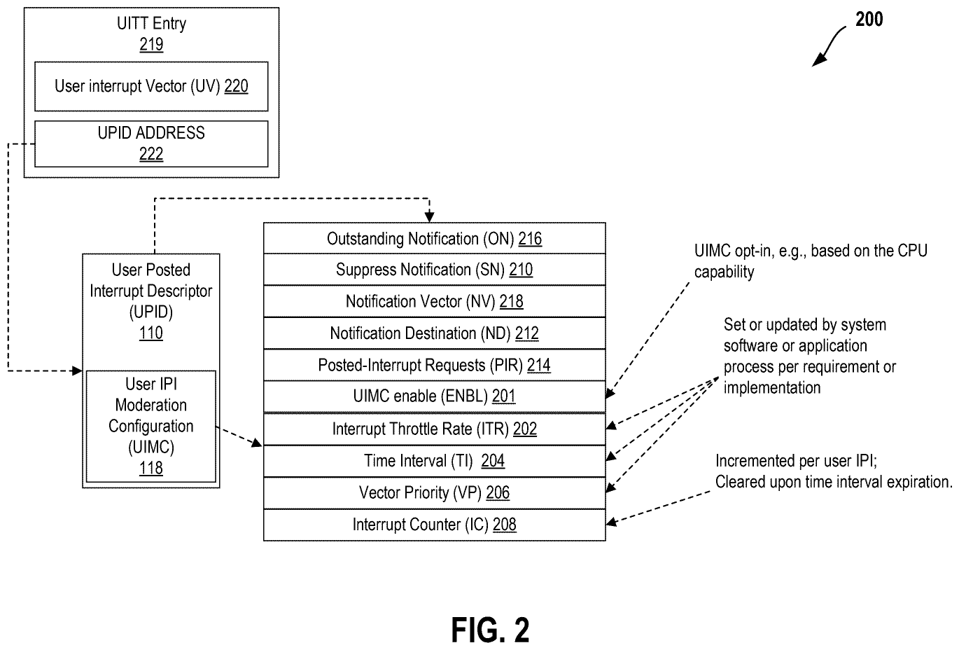

In at least one embodiment, a Vector Priority (VP) value (see, e.g., VP 206 of FIG. 2) may be used to allow only higher-priority user IPI to be generated. The UIMC 118 contains the current vector priority that the receiver processor 120 may accept. The vector priority may be dynamically updated by the receiver process 120 on demand. In turn, the execution of a SENDUIPI instruction will determine if the user IPI should be generated to the local APIC 116 based on the comparison result of the current vector priority of the receiver and the priority of the user IPI to be issued.

FIG. 2 illustrates a block diagram of an extended UPID 200 with User IPI Moderation Configuration (UIMC), according to an embodiment. The UPID 110 records user interrupt information in kernel. An embodiment extends the UPID by introducing the User IPI Moderation Configuration (UIMC) 118. As shown in FIG. 2, the UIMC 118 may store/include one or more values such as: a UIMC enable (ENBL) 201, an Interrupt Throttle Rate (ITR) 202, Time Interval (TI) 204, VP 206, and/or Interrupt Counter (IC) 208. The UIMC.ITR 202, UIMC.TI 204, and UIMC. VP 206 may be configured by a receiver process (such as the receiver process 120 of FIG. 1) or system software/application process per the requirements or implementations. The UIMC.IC 208 may be incremented when a user IPI is initiated/attempted and be cleared periodically based on the setting of UIMC. TI 204.

Some UPID implementations may contain a Suppression Notification (SN) 210 (e.g., to determine if post user interrupts are present in this descriptor), a Notification Destination (ND) 212 (e.g., indicating the processor or local APIC where the receiver processor is running, such as the processor/CPU 122 and local APIC 116 of FIG. 1), Posted-Interrupt Requests (PIR) 214 (e.g., including one bit for each user-interrupt vector 220), an Outstanding Notification (ON) 216 (e.g., if this bit is set, there is a notification outstanding for one or more user interrupts in PIR 214), and/or a Notification Vector (NV) 218 (e.g., including one bit for each notification). As shown, each entry 219 of UITT 108 of FIG. 1 may include a User interrupt Vector (UV) 220 (e.g., which is pushed on the stack as part of user-interrupt delivery) and a UPID address 222 (e.g., to point to a corresponding UPID 110).

In one embodiment, an opt-in bit may also be added to a register (e.g., called UINTR_MISC_MSR) to allow a SENDUIPI instruction to read this new extended UPID 110 during execution. For example, a 32-bit register (IA32_UINTR_MISC MSR (MSR address 988H)) may be used. The MSR may have the following format:
bits 31:0 are User-Interrupt Target Table Size (UITTSZ) (e.g., where this value is the highest index of a valid entry in the UITT 108);
bits 39:32 are User-Interrupt Notification Vector (UINV) (e.g., which is the vector of those ordinary interrupts that are treated as user-interrupt notifications and when the logical processor receives a user-interrupt notification, it processes the user interrupts in the user posted-interrupt descriptor (UPID) referenced by the UPID address);
bit 40 is UIMC enable;
bits 63:41 are reserved.

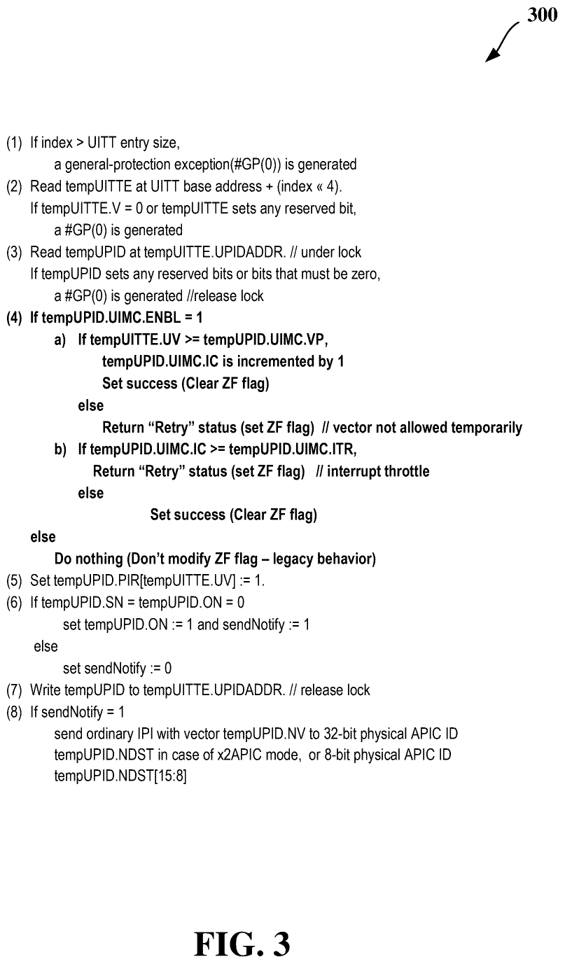

One implementation may be primarily suited to support moderation of user IPIs. FIG. 3 illustrates a sample pseudocode using the SENDUIPI instruction for user IPI moderation, according to an embodiment.

In FIG. 3, “UITT” refers to a User Interrupt Target Table, “tempUITTE” refers to a UITT entry variable, “tempUITTE. V” refers to UITT entry valid bit, “tempUPID” refers to a User Posted Interrupt Descriptor variable, “tempUITTE. UPIDADDR” refers to a UITT entry UPID address, “tempUITTE.UV” refers to a UITTE entry User interrupt Vector, “tempUPID. UIMC. VP” refers to a UID UIMC Vector Priority variable, “tempUPID. UIMC.IC” refers to a UPID UIMC Interrupt Counter, “tempUPID.UIMC.ITR” refers to a UPID UIMC Interrupt Throttle Rate variable, “tempUPID.PIR” refers to a UPID Posted-Interrupt Requests variable, “UPID.SN” refers to a UPID Suppress Notification, “UPID.ON” refers to a UPID Outstanding Notification, “sendNotifiy” refers to a variable indicating whether a notification is to be sent, “tempUPID.NV” refers to a UPID Notification Vector variable, and “tempUPID.NDST” refers to a UPID Notification Destination variable.

The two steps (4)a and (4)b are provided in accordance with an embodiment. It is mainly up to the receiver process 120 of FIG. 1 to determine the update of the vector priority (UPID.UIMC.VP) according to its situation/implementation. There may be other factors which may be introduced for UPID. UIMC. VP setting.

As for a return retry status, the sender of a user interrupt when throttled may want to know that its attempt to send a user IPI (e.g., using a SENDUIPI instruction) has been unsuccessful. This would allow the sender to retry sending a user IPI, e.g., after a suitable backoff time. Thus, a new opt-in mechanism to return a retry status via ZF flag in a register (such as an RFLAGS register) may be used. For example, ZF=0 (success) reports that the UV was set atomically to receiver's UPID. PIR. This does not guarantee that the interrupt was delivered to the receiver. It may be delivered later based on the receiver state. ZF=1 (retry) reports that the UPID was not updated. This status is returned if the write operation to the UPID.PIR was not accepted due to throttling or priority moderation.

As for a user IPI Moderation opt-in mentioned before, the SENDUIPI instruction currently does not return an error status. But an option to return an error status may be added to enhance the interrupt moderation architecture. The UIMC feature can be made opt-in on a per-application basis by the operating system. The ZF flag may be impacted only for applications that have opted in. Another option is to generate a #GP(0) upon throttling or priority moderation and let the operating system decode the instruction and deliver an appropriate error status to user space. Also, while some embodiments discuss IPIs sent to user spaces, embodiments are not limited to user spaces and the user IPIs discussed herein may be exchanged with other space in a computing system such between kernels, etc.

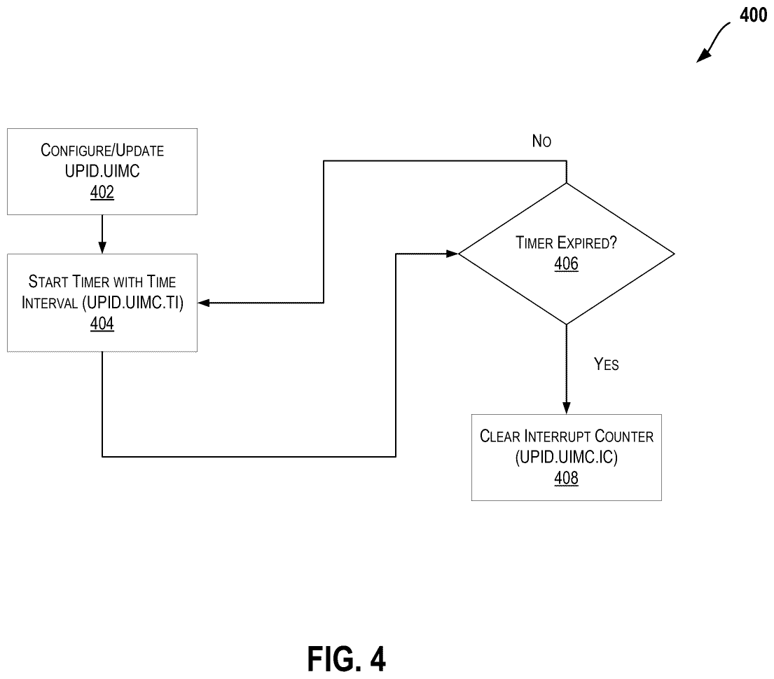

FIG. 4 illustrates a flow diagram of a method 400 for periodical clearance of an interrupt counter, according to an embodiment. One or more of the operations of the method 400 may be performed by one or more components of FIGS. 1 to 3.

Referring to FIGS. 1 to 4, at an operation 402, a receiver process (such as the receiver process 120) configures/updates the UIMC 118 of the UPID 110 (UPID.UIMC). At an operation 404, a timer (e.g., per UPID or per core) is started for a given time interval (UID.UIMC.TI). Once the timer expires at an operation 406, the interrupt counter (UPID.UIMC.IC) is cleared. Generally, the UPID. UIMC.TI could be customized for different UPID entries. The system software (e.g., an operating system or a software application) can provision different options for time intervals to the receiver process for selection or assign a specific time interval to the receiver process according to its process attributes. Other alternative may be adopted such as implementing one timer per processor core, where all the receiver processes then share the same timer and time interval. This approach could simplify the realization and reduce the overhead of multiple timers with different UPID. UIMC.TI values.

Furthermore, there may be other implementation alternative for the user IPI moderation at receiver side without enhancing the SENDUIPI instruction, e.g., by incrementing UPID.UIMC.IC based on a vector priority comparison, where an interrupt counter and throttle value are compared (i.e., integrating similar behavior as the two steps of operation (4) in FIG. 3) before starting a user-interrupt delivery procedure at the receiver side. Moreover, the SENDUIPI instruction enhancement may suppress unnecessary (or malicious) IPIs on system bus from the sender process. This enhancement would benefit the whole system.

Moreover, in implementations with virtual interrupts such as Secure Encrypted Virtualization (SEV), two communication modes (restricted/alternate injection) between a Virtual Machine (VM) and hypervisor may be used to support interrupt/exception protection. These two modes associate with a Virtual Machine Privilege Level (VMPL). For example, a VMPL0 may interact with the hypervisor with a restricted injection mode and another VMPL3 may interact with VMPL0 with the alternate injection mode. In this scenario, VMPL0 controls a VM Save Area (VMSA). In an embodiment, the VMSA may adopt the same or similar information as the UITT and/or UIMC. In turn, the interrupt moderation (e.g., interrupt rate throttling) discussed herein may be applied to VMSA as well. As a result, a VMPL0 could manipulate the virtual interrupts queueing/injection and perform APIC emulation based on the moderation setting in VMSA in an embodiment.

Additionally, some embodiments may be applied in computing systems that include one or more processors (e.g., where the one or more processors may include one or more processor cores), such as those discussed with reference to FIG. 1 et seq., including for example a desktop computer, a workstation, a computer server, a server blade, or a mobile computing device. The mobile computing device may include a smartphone, tablet, UMPC (Ultra-Mobile Personal Computer), laptop computer, Ultrabook™ computing device, wearable devices (such as a smart watch, smart ring, smart bracelet, or smart glasses), etc.

### Example Computer Architectures

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

FIG. 5 illustrates an example computing system. Multiprocessor system 500 is an interfaced system and includes a plurality of processors or cores including a first processor 570 and a second processor 580 coupled via an interface 550 such as a point-to-point (P-P) interconnect, a fabric, and/or bus. In some examples, the first processor 570 and the second processor 580 are homogeneous. In some examples, first processor 570 and the second processor 580 are heterogenous. Though the example system 500 is shown to have two processors, the system may have three or more processors, or may be a single processor system. In some examples, the computing system is a system on a chip (SoC).

Processors 570 and 580 are shown including integrated memory controller (IMC) circuitry 572 and 582, respectively. Processor 570 also includes interface circuits 576 and 578; similarly, second processor 580 includes interface circuits 586 and 588. Processors 570, 580 may exchange information via the interface 550 using interface circuits 578, 588. IMCs 572 and 582 couple the processors 570, 580 to respective memories, namely a memory 532 and a memory 534, which may be portions of main memory locally attached to the respective processors.

Processors 570, 580 may each exchange information with a network interface (NW I/F) 590 via individual interfaces 552, 554 using interface circuits 576, 594, 586, 598. The network interface 590 (e.g., one or more of an interconnect, bus, and/or fabric, and in some examples is a chipset) may optionally exchange information with a coprocessor 538 via an interface circuit 592. In some examples, the coprocessor 538 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 570, 580 or outside of both processors, yet connected with the processors via an interface such as P-P interconnect, such that either or both processors' local cache information may be stored in the shared cache if a processor is placed into a low power mode.

Network interface 590 may be coupled to a first interface 516 via interface circuit 596. In some examples, first interface 516 may be an interface such as a Peripheral Component Interconnect (PCI) interconnect, a PCI Express interconnect or another I/O interconnect. In some examples, first interface 516 is coupled to a power control unit (PCU) 517, which may include circuitry, software, and/or firmware to perform power management operations with regard to the processors 570, 580 and/or co-processor 538. PCU 517 provides control information to a voltage regulator (not shown) to cause the voltage regulator to generate the appropriate regulated voltage. PCU 517 also provides control information to control the operating voltage generated. In various examples, PCU 517 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 517 is illustrated as being present as logic separate from the processor 570 and/or processor 580. In other cases, PCU 517 may execute on a given one or more of cores (not shown) of processor 570 or 580. In some cases, PCU 517 may be implemented as a microcontroller (dedicated or general-purpose) or other control logic configured to execute its own dedicated power management code, sometimes referred to as P-code. In yet other examples, power management operations to be performed by PCU 517 may be implemented externally to a processor, such as by way of a separate power management integrated circuit (PMIC) or another component external to the processor. In yet other examples, power management operations to be performed by PCU 517 may be implemented within BIOS or other system software.

Various I/O devices 514 may be coupled to first interface 516, along with a bus bridge 518 which couples first interface 516 to a second interface 520. In some examples, one or more additional processor(s) 515, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 516. In some examples, second interface 520 may be a low pin count (LPC) interface. Various devices may be coupled to second interface 520 including, for example, a keyboard and/or mouse 522, communication devices 527 and storage circuitry 528. Storage circuitry 528 may be one or more non-transitory machine-readable storage media as described below, such as a disk drive or other mass storage device which may include instructions/code and data 530 and may implement the storage for one or more instructions in some examples. Further, an audio I/O 524 may be coupled to second interface 520. Note that other architectures than the point-to-point architecture described above are possible. For example, instead of the point-to-point architecture, a system such as multiprocessor system 500 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

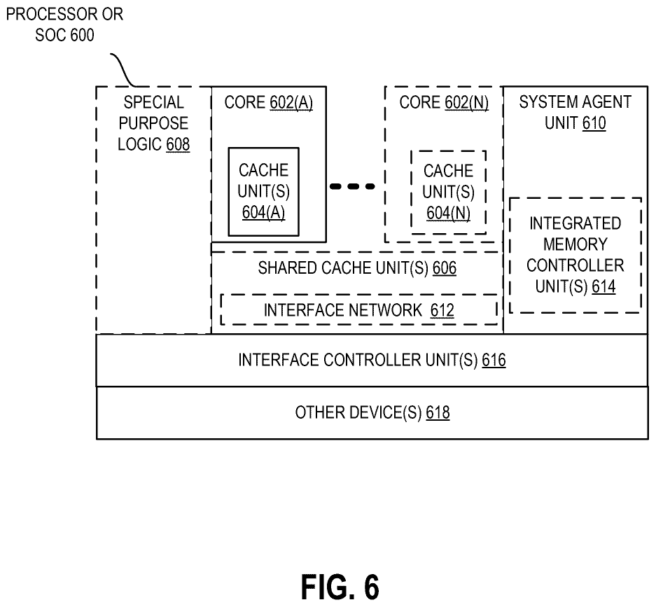

FIG. 6 illustrates a block diagram of an example processor and/or SoC 600 that may have one or more cores and an integrated memory controller. The solid lined boxes illustrate a processor 600 with a single core 602(A), system agent unit circuitry 610, and a set of one or more interface controller unit(s) circuitry 616, while the optional addition of the dashed lined boxes illustrates an alternative processor 600 with multiple cores 602(A)-(N), a set of one or more integrated memory controller unit(s) circuitry 614 in the system agent unit circuitry 610, and special purpose logic 608, as well as a set of one or more interface controller units circuitry 616. Note that the processor 600 may be one of the processors 570 or 580, or co-processor 538 or 515 of FIG. 5.

Thus, different implementations of the processor 600 may include: 1) a CPU with the special purpose logic 608 being integrated graphics and/or scientific (throughput) logic (which may include one or more cores, not shown), and the cores 602(A)-(N) being one or more general purpose cores (e.g., general purpose in-order cores, general purpose out-of-order cores, or a combination of the two); 2) a coprocessor with the cores 602(A)-(N) being a large number of special purpose cores intended primarily for graphics and/or scientific (throughput); and 3) a coprocessor with the cores 602(A)-(N) being a large number of general purpose in-order cores. Thus, the processor 600 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 600 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 604(A)-(N) within the cores 602(A)-(N), a set of one or more shared cache unit(s) circuitry 606, and external memory (not shown) coupled to the set of integrated memory controller unit(s) circuitry 614. The set of one or more shared cache unit(s) circuitry 606 may include one or more mid-level caches, such as level 2 (L2), level 3 (L3), level 4 (L4), or other levels of cache, such as a last level cache (LLC), and/or combinations thereof. While in some examples interface network circuitry 612 (e.g., a ring interconnect) interfaces the special purpose logic 608 (e.g., integrated graphics logic), the set of shared cache unit(s) circuitry 606, and the system agent unit circuitry 610, alternative examples use any number of well-known techniques for interfacing such units. In some examples, coherency is maintained between one or more of the shared cache unit(s) circuitry 606 and cores 602(A)-(N). In some examples, interface controller units circuitry 616 couple the cores 602 to one or more other devices 618 such as one or more I/O devices, storage, one or more communication devices (e.g., wireless networking, wired networking, etc.), etc.

In some examples, one or more of the cores 602(A)-(N) are capable of multi-threading. The system agent unit circuitry 610 includes those components coordinating and operating cores 602(A)-(N). The system agent unit circuitry 610 may include, for example, power control unit (PCU) circuitry and/or display unit circuitry (not shown). The PCU may be or may include logic and components needed for regulating the power state of the cores 602(A)-(N) and/or the special purpose logic 608 (e.g., integrated graphics logic). The display unit circuitry is for driving one or more externally connected displays.

The cores 602(A)-(N) may be homogenous in terms of instruction set architecture (ISA). Alternatively, the cores 602(A)-(N) may be heterogeneous in terms of ISA; that is, a subset of the cores 602(A)-(N) may be capable of executing an ISA, while other cores may be capable of executing only a subset of that ISA or another ISA.

### Example Core Architectures-in-Order and Out-of-Order Core Block Diagram

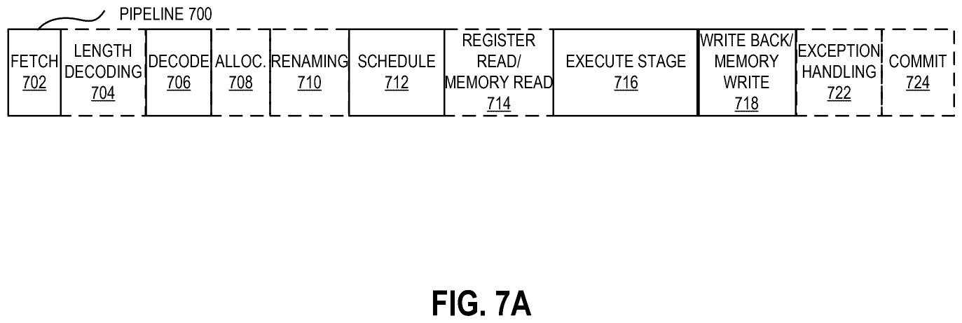

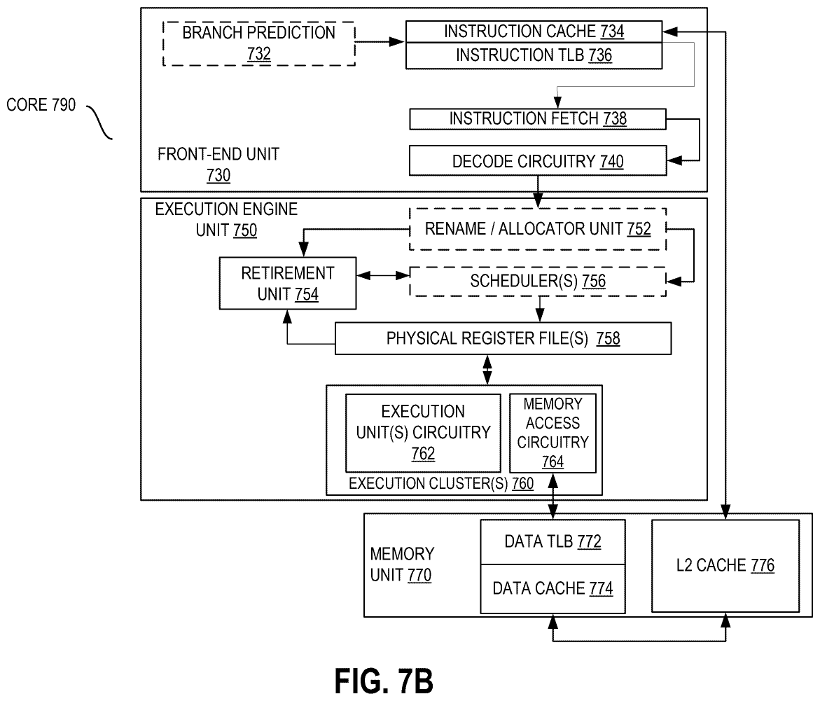

FIG. 7(A) is a block diagram illustrating both an example in-order pipeline and an example register renaming, out-of-order issue/execution pipeline according to examples. FIG. 7(B) is a block diagram illustrating both an example in-order architecture core and an example register renaming, out-of-order issue/execution architecture core to be included in a processor according to examples. The solid lined boxes in FIGS. 7(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 7(A), a processor pipeline 700 includes a fetch stage 702, an optional length decoding stage 704, a decode stage 706, an optional allocation (Alloc) stage 708, an optional renaming stage 710, a schedule (also known as a dispatch or issue) stage 712, an optional register read/memory read stage 714, an execute stage 716, a write back/memory write stage 718, an optional exception handling stage 722, and an optional commit stage 724. One or more operations can be performed in each of these processor pipeline stages. For example, during the fetch stage 702, one or more instructions are fetched from instruction memory, and during the decode stage 706, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 706 and the register read/memory read stage 714 may be combined into one pipeline stage. In one example, during the execute stage 716, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 7(B) may implement the pipeline 700 as follows: 1) the instruction fetch circuitry 738 performs the fetch and length decoding stages 702 and 704; 2) the decode circuitry 740 performs the decode stage 706; 3) the rename/allocator unit circuitry 752 performs the allocation stage 708 and renaming stage 710; 4) the scheduler(s) circuitry 756 performs the schedule stage 712; 5) the physical register file(s) circuitry 758 and the memory unit circuitry 770 perform the register read/memory read stage 714; the execution cluster(s) 760 perform the execute stage 716; 6) the memory unit circuitry 770 and the physical register file(s) circuitry 758 perform the write back/memory write stage 718; 7) various circuitry may be involved in the exception handling stage 722; and 8) the retirement unit circuitry 754 and the physical register file(s) circuitry 758 perform the commit stage 724.

FIG. 7(B) shows a processor core 790 including front-end unit circuitry 730 coupled to execution engine unit circuitry 750, and both are coupled to memory unit circuitry 770. The core 790 may be a reduced instruction set architecture computing (RISC) core, a complex instruction set architecture computing (CISC) core, a very long instruction word (VLIW) core, or a hybrid or alternative core type. As yet another option, the core 790 may be a special-purpose core, such as, for example, a network or communication core, compression engine, coprocessor core, general purpose computing graphics processing unit (GPGPU) core, graphics core, or the like.

The front-end unit circuitry 730 may include branch prediction circuitry 732 coupled to instruction cache circuitry 734, which is coupled to an instruction translation lookaside buffer (TLB) 736, which is coupled to instruction fetch circuitry 738, which is coupled to decode circuitry 740. In one example, the instruction cache circuitry 734 is included in the memory unit circuitry 770 rather than the front-end circuitry 730. The decode circuitry 740 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 740 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 740 may be implemented using various different mechanisms. Examples of suitable mechanisms include, but are not limited to, look-up tables, hardware implementations, programmable logic arrays (PLAs), microcode read only memories (ROMs), etc. In one example, the core 790 includes a microcode ROM (not shown) or other medium that stores microcode for certain macroinstructions (e.g., in decode circuitry 740 or otherwise within the front-end circuitry 730). In one example, the decode circuitry 740 includes a micro-operation (micro-op) or operation cache (not shown) to hold/cache decoded operations, micro-tags, or micro-operations generated during the decode or other stages of the processor pipeline 700. The decode circuitry 740 may be coupled to rename/allocator unit circuitry 752 in the execution engine circuitry 750.

The execution engine circuitry 750 includes the rename/allocator unit circuitry 752 coupled to retirement unit circuitry 754 and a set of one or more scheduler(s) circuitry 756. The scheduler(s) circuitry 756 represents any number of different schedulers, including reservations stations, central instruction window, etc. In some examples, the scheduler(s) circuitry 756 can include arithmetic logic unit (ALU) scheduler/scheduling circuitry, ALU queues, address generation unit (AGU) scheduler/scheduling circuitry, AGU queues, etc. The scheduler(s) circuitry 756 is coupled to the physical register file(s) circuitry 758. Each of the physical register file(s) circuitry 758 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 758 includes vector registers unit circuitry, writemask registers unit circuitry, and scalar register unit circuitry. These register units may provide architectural vector registers, vector mask registers, general-purpose registers, etc. The physical register file(s) circuitry 758 is coupled to the retirement unit circuitry 754 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 754 and the physical register file(s) circuitry 758 are coupled to the execution cluster(s) 760. The execution cluster(s) 760 includes a set of one or more execution unit(s) circuitry 762 and a set of one or more memory access circuitry 764. The execution unit(s) circuitry 762 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 756, physical register file(s) circuitry 758, and execution cluster(s) 760 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster-and in the case of a separate memory access pipeline, certain examples are implemented in which only the execution cluster of this pipeline has the memory access unit(s) circuitry 764). It should also be understood that where separate pipelines are used, one or more of these pipelines may be out-of-order issue/execution and the rest in-order.

In some examples, the execution engine unit circuitry 750 may perform load store unit (LSU) address/data pipelining to an Advanced Microcontroller Bus (AMB) interface (not shown), and address phase and writeback, data phase load, store, and branches.

The set of memory access circuitry 764 is coupled to the memory unit circuitry 770, which includes data TLB circuitry 772 coupled to data cache circuitry 774 coupled to level 2 (L2) cache circuitry 776. In one example, the memory access circuitry 764 may include load unit circuitry, store address unit circuitry, and store data unit circuitry, each of which is coupled to the data TLB circuitry 772 in the memory unit circuitry 770. The instruction cache circuitry 734 is further coupled to the level 2 (L2) cache circuitry 776 in the memory unit circuitry 770. In one example, the instruction cache 734 and the data cache 774 are combined into a single instruction and data cache (not shown) in L2 cache circuitry 776, level 3 (L3) cache circuitry (not shown), and/or main memory. The L2 cache circuitry 776 is coupled to one or more other levels of cache and eventually to a main memory.

The core 790 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 790 includes logic to support a packed data instruction set architecture extension (e.g., AVX1, AVX2), thereby allowing the operations used by many multimedia applications to be performed using packed data.

### Example Execution Unit(s) Circuitry

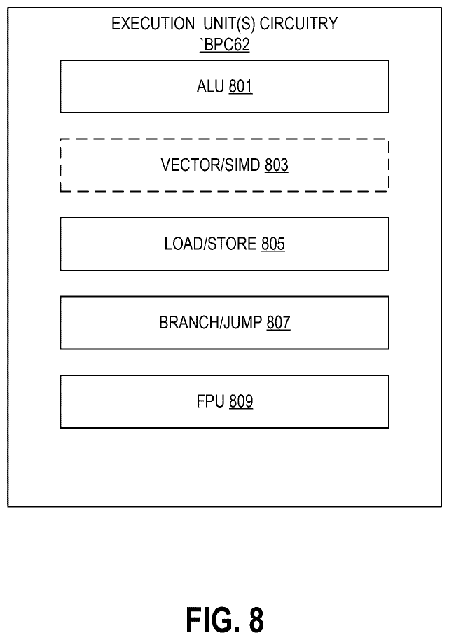

FIG. 8 illustrates examples of execution unit(s) circuitry, such as execution unit(s) circuitry 762 of FIG. 7(B). As illustrated, execution unit(s) circuity 762 may include one or more ALU circuits 801, optional vector/single instruction multiple data (SIMD) circuits 803, load/store circuits 805, branch/jump circuits 807, and/or Floating-point unit (FPU) circuits 809. ALU circuits 801 perform integer arithmetic and/or Boolean operations. Vector/SIMD circuits 803 perform vector/SIMD operations on packed data (such as SIMD/vector registers). Load/store circuits 805 execute load and store instructions to load data from memory into registers or store from registers to memory. Load/store circuits 805 may also generate addresses. Branch/jump circuits 807 cause a branch or jump to a memory address depending on the instruction. FPU circuits 809 perform floating-point arithmetic. The width of the execution unit(s) circuitry 762 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

In this description, numerous specific details are set forth to provide a more thorough understanding. However, it will be apparent to one of skill in the art that the embodiments described herein may be practiced without one or more of these specific details. In other instances, well-known features have not been described to avoid obscuring the details of the present embodiments.

The following examples pertain to further embodiments. Example 1 includes 1 includes an apparatus comprising: a processor to execute a receiver process to process a user Inter-Processor Interrupt (IPI) from a sender process; and a memory to store User Inter-Processor Interrupt Moderation Configuration (UIMC) data to be accessed by the receiver process; wherein, in response to a comparison of a number of invocations of the user IPI during a time interval and an interrupt throttle rate, the processor is to determine whether to drop the user IPI.

Example 2 includes the apparatus of example 1, wherein the receiver process is to drop the user IPI in response to a determination that the number of invocations of the user IPI during the time interval exceeds the interrupt throttle rate. Example 3 includes the apparatus of any one of examples 1 to 2, wherein the receiver process is to transmit a retry signal to the sender process in response to dropping of the user IPI. Example 4 includes the apparatus of any one of examples 1 to 3, wherein the receiver process is to transmit a retry signal to the sender process in response to dropping of the user IPI based on a status of an opt-in bit. Example 5 includes the apparatus of any one of examples 1 to 4, wherein the UIMC data comprises one or more of: the interrupt throttle rate, an interrupt counter, and the time interval. Example 6 includes the apparatus of any one of examples 1 to 5, wherein the interrupt counter is to store a number of invocations of a select user IPI. Example 7 includes the apparatus of any one of examples 1 to 6, wherein the interrupt counter is to be cleared after expiration of a timer. Example 8 includes the apparatus of any one of examples 1 to 7, further comprising an Advanced Programmable Interrupt Controller (APIC) to receive and process one or more user IPIs.

Example 9 includes the apparatus of any one of examples 1 to 8, wherein the receiver process is to drop the user IPI in response to a determination that the number of invocations of the user IPI during the time interval exceeds the interrupt throttle rate without generating an IPI to the APIC. Example 10 includes the apparatus of any one of examples 1 to 9, wherein the APIC is to receive the user IPI from the sender process. Example 11 includes the apparatus of any one of examples 1 to 10, wherein the APIC is to receive the user IPI from the sender process, wherein the at least one user IPI is to be generated in response to execution of an instruction. Example 12 includes the apparatus of any one of examples 1 to 11, wherein the APIC is to receive the user IPI from the sender process over a processor system bus. Example 13 includes the apparatus of any one of examples 1 to 12, wherein a User Posted Interrupt Descriptor (UPID) includes the UIMC data. Example 14 includes the apparatus of any one of examples 1 to 13, wherein a User Interrupt Target Table (UITT) is to store at least one entry, wherein the at least one entry is to identify an address for the UIMC data. Example 15 includes the apparatus of any one of examples 1 to 14, wherein at least one of the UITT and the UIMC are to store virtual machine interrupt data to support moderation of one or more virtual machine user IPIs. Example 16 includes the apparatus of any one of examples 1 to 15, wherein the user IPI is to be initiated in response to execution of an instruction. Example 17 includes the apparatus of any one of examples 1 to 16, wherein the instruction is to initiate the user IPI in response to the UIMC data based on a status of an opt-in bit. Example 18 includes the apparatus of any one of examples 1 to 17, wherein a one or more integrated circuit dies are to comprise the processor and the memory.

Example 19 includes a method comprising: processing a user Inter-Processor Interrupt (IPI) from a sender process; and storing User Inter-Processor Interrupt Moderation Configuration (UIMC) data to be accessed by a receiver process in a memory; and determining whether to drop the user IPI based at least in part on a comparison of a number of invocations of the user IPI during a time interval and an interrupt throttle rate.

Example 20 includes the method of example 19. further comprising the receiver process dropping the user IPI in response to a determination that the number of invocations of the user IPI during the time interval exceeds the interrupt throttle rate. Example 21 includes the method of any one of examples 19 to 20, further comprising the receiver process transmitting a retry signal to the sender process in response to dropping of the user IPI. Example 22 includes the method of any one of examples 19 to 21, further comprising the receiver process transmitting a retry signal to the sender process in response to dropping of the user IPI based on a status of an opt-in bit. Example 23 includes the method of any one of examples 19 to 22. wherein the UIMC data comprises one or more of: the interrupt throttle rate, an interrupt counter, and the time interval. Example 24 includes the method of any one of examples 19 to 23, further comprising the interrupt counter storing a number of invocations of a select user IPI.

Example 25 includes a computer-readable medium comprising one or more instructions that when executed on a processor configure the processor to perform one or more operations of any one of examples 18 to 24. Example 26 includes an apparatus comprising means to perform a method as set forth in any preceding example. Example 27 includes machine-readable storage including machine-readable instructions, when executed, to implement a method or realize an apparatus as set forth in any preceding example.

In various embodiments, one or more operations discussed with reference to FIG. 1 et seq. may be performed by one or more components (interchangeably referred to herein as “logic”) discussed with reference to any of the figures.

In some embodiments, the operations discussed herein, e.g., with reference to FIG. 1 et seq., may be implemented as hardware (e.g., logic circuitry), software, firmware, or combinations thereof, which may be provided as a computer program product, e.g., including one or more tangible (e.g., non-transitory) machine-readable or computer-readable media having stored thereon instructions (or software procedures) used to program a computer to perform a process discussed herein. The machine-readable medium may include a storage device or memory such as those discussed with respect to the figures.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Further, while various embodiments described herein may use the term System-on-a-Chip or System-on-Chip (“SoC” or “SOC”) to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various embodiments of the present disclosure, a device or system may have one or more processors (e.g., one or more processor cores) and associated circuitry (e.g., I/O circuitry, power delivery circuitry, etc.) arranged in a disaggregated collection of discrete dies, tiles, and/or chiplets (e.g., one or more discrete processor core die arranged adjacent to one or more other die such as a memory die, I/O die, etc.). In such disaggregated devices and systems, the various dies, tiles, and/or chiplets may be physically and/or electrically coupled together by a package structure including, for example, various packaging substrates, interposers, active interposers, photonic interposers, interconnect bridges, and the like. The disaggregated collection of discrete dies, tiles, and/or chiplets may also be part of a System-on-Package (“SoP”).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
a processor to execute a receiver process to process a user Inter-Processor Interrupt (IPI) from a sender process; and
a memory to store User Inter-Processor Interrupt Moderation Configuration (UIMC) data to be accessed by the receiver process;
wherein, in response to a comparison of a number of invocations of the user IPI during a time interval and an interrupt throttle rate, the processor is to determine whether to drop the user IPI.

2. The apparatus of claim 1, wherein the receiver process is to drop the user IPI in response to a determination that the number of invocations of the user IPI during the time interval exceeds the interrupt throttle rate.

3. The apparatus of any one of claims 1 to 2, wherein the receiver process is to transmit a retry signal to the sender process in response to dropping of the user IPI.

4. The apparatus of any one of claims 1 to 3, wherein the receiver process is to transmit a retry signal to the sender process in response to dropping of the user IPI based on a status of an opt-in bit.

5. The apparatus of any one of claims 1 to 4, wherein the UIMC data comprises one or more of: the interrupt throttle rate, an interrupt counter, and the time interval.

6. The apparatus of any one of claims 1 to 5, wherein the interrupt counter is to store a number of invocations of a select user IPI.

7. The apparatus of any one of claims 1 to 6, wherein the interrupt counter is to be cleared after expiration of a timer.

8. The apparatus of any one of claims 1 to 7, further comprising an Advanced Programmable Interrupt Controller (APIC) to receive and process one or more user IPIs.

9. The apparatus of any one of claims 1 to 8, wherein the receiver process is to drop the user IPI in response to a determination that the number of invocations of the user IPI during the time interval exceeds the interrupt throttle rate without generating an IPI to the APIC.

10. The apparatus of any one of claims 1 to 9, wherein the APIC is to receive the user IPI from the sender process.

11. The apparatus of any one of claims 1 to 10, wherein the APIC is to receive the user IPI from the sender process, wherein the at least one user IPI is to be generated in response to execution of an instruction.

12. The apparatus of any one of claims 1 to 11, wherein the APIC is to receive the user IPI from the sender process over a processor system bus.

13. The apparatus of any one of claims 1 to 12, wherein a User Posted Interrupt Descriptor (UPID) includes the UIMC data.

14. The apparatus of any one of claims 1 to 13, wherein a User Interrupt Target Table (UITT) is to store at least one entry, wherein the at least one entry is to identify an address for the UIMC data.

15. The apparatus of any one of claims 1 to 14, wherein at least one of the UITT and the UIMC are to store virtual machine interrupt data to support moderation of one or more virtual machine user IPIs.

16. The apparatus of any one of claims 1 to 15, wherein the user IPI is to be initiated in response to execution of an instruction.

17. The apparatus of any one of claims 1 to 16, wherein the instruction is to initiate the user IPI in response to the UIMC data based on a status of an opt-in bit.

18. The apparatus of any one of claims 1 to 17, wherein a one or more integrated circuit dies are to comprise the processor and the memory.

19. A method comprising:
processing a user Inter-Processor Interrupt (IPI) from a sender process; and
storing User Inter-Processor Interrupt Moderation Configuration (UIMC) data to be accessed by a receiver process in a memory; and
determining whether to drop the user IPI based at least in part on a comparison of a number of invocations of the user IPI during a time interval and an interrupt throttle rate.

20. The method of claim 19, further comprising the receiver process dropping the user IPI in response to a determination that the number of invocations of the user IPI during the time interval exceeds the interrupt throttle rate.

21. The method of any one of claims 19 to 20, further comprising the receiver process transmitting a retry signal to the sender process in response to dropping of the user IPI.

22. The method of any one of claims 19 to 21, further comprising the receiver process transmitting a retry signal to the sender process in response to dropping of the user IPI based on a status of an opt-in bit.

23. The method of any one of claims 19 to 22, wherein the UIMC data comprises one or more of: the interrupt throttle rate, an interrupt counter, and the time interval.

24. The method of any one of claims 19 to 23, further comprising the interrupt counter storing a number of invocations of a select user IPI.

25. A computer-readable medium comprising one or more instructions that when executed on a processor configure the processor to perform one or more operations of any one of claims 18 to 24.
